(19) United States
(12) Patent Application Publication
(10) Pub. No.: US 2013/0330642 A1
(43) Pub. Date: Dec. 12, 2013

(54) FUEL CELL SYSTEM

(71) Applicant: Keisuke Fujita, Susono-shi (JP)

(72) Inventor: Keisuke Fujita, Susono-shi (JP)

(73) Assignee: TOYOTA JIDOSHA KABUSHIKI KAISHA, Toyota-shi, Aichi (JP)

(21) Appl. No.: 13/379,198

(22) PCT Filed: Mar. 1, 2011
(86) PCT No.: PCT/JP2011/054642

§ 371 Date: Jan. 18, 2012

(51) Int. Cl. H01M 8/04

(52) U.S. Cl. CPC H01M 8/04291
USPC 429/413

(57) ABSTRACT

A fuel cell system including a fuel cell which includes a single cell including a membrane electrode assembly which includes an anode electrode provided on one surface of a polymer electrolyte membrane and a cathode electrode provided on the other side of the same, wherein the fuel cell system includes a means for controlling the fuel cell so that relative humidity RH_{C} inside the cathode electrode and relative humidity RH_{A} inside the anode electrode satisfy the following formula (1) at least when the fuel cell is in intermittent operation:

RH_{C}>RH_{A} Formula (1):

wherein RH_{C}≧100%.

### TECHNICAL FIELD

The present invention relates to a fuel cell system which prevents deterioration of a polymer electrolyte membrane in advance.

### BACKGROUND ART

A fuel cell converts chemical energy directly to electrical energy by supplying a fuel and an oxidant to two electrically-connected electrodes and causing electrochemical oxidation of the fuel. Unlike thermal power generation, fuel cells are not limited by Carnot cycle, so that they can show high energy conversion efficiency. In general, a fuel cell is formed by stacking a plurality of single fuel cells each of which has a membrane electrode assembly as a fundamental structure, in which an electrolyte membrane is sandwiched between a pair of electrodes. Especially, a solid polymer electrolyte fuel cell which uses a solid polymer electrolyte membrane as the electrolyte membrane is attracting attention as a portable and mobile power source because it has such advantages that it can be downsized easily, operate at low temperature, etc.

In a solid polymer electrolyte fuel cell, the reaction represented by the following formula (I) proceeds at an anode (fuel electrode) in the case of using hydrogen as fuel:

H₂→2H⁺+2e⁻ Formula (I):

Electrons generated by the reaction represented by the formula (I) pass through an external circuit, work by an external load, and then reach a cathode (oxidant electrode). Protons generated by the reaction represented by the formula (I) are, in the state of being hydrated and by electro-osmosis, transferred from the anode side to the cathode side through the solid polymer electrolyte membrane.

In the case of using oxygen as an oxidant, the reaction represented by the following formula (II) proceeds at the cathode:

2H⁺+(1/2)O₂+2e⁻→H₂O Formula (II):

Water produced at the cathode passes mainly through a gas diffusion layer and is discharged to the outside. Accordingly, fuel cells are clean power source that produces no emissions except water.

When a small amount of water is produced by the reaction represented by the formula (II), there is a problem that hydrogen peroxide or radicals produced inside the fuel cell are condensed and electrolyte membrane is deteriorated by the hydrogen peroxide and radicals.

As an invention aimed at solving the problem of electrolyte membrane deterioration especially in the case of using a hydrocarbon electrolyte membrane, Patent literature 1 discloses a fuel cell system comprising a fuel cell having a hydrocarbon electrolyte membrane, a detecting means for detecting a volume index value of produced water, which shows a water volume produced by power generation of the fuel cell, and a power generation control means for establishing a subsequent minimum value of electric current generated by the fuel cell, if the volume of water produced by power generation during a fixed period, is less than the pre-established value.

### CITATION LIST

Patent Literature 1: Japanese Patent Application Laid-Open No. 2010-44908

### SUMMARY OF INVENTION

### Technical Problem

In paragraph 0007 of the Specification of Patent Literature is described that the electrolyte membrane can be humidified by the water produced by power generation. However, the water produced by power generation is produced only from the cathode and locally; therefore, in the fuel cell system, when there is a water deficiency in the parts other than the cathode, such as the anode, and condensation of hydrogen peroxide water or radicals takes place, the technique disclosed in the patent literature cannot prevent deterioration of an electrolyte membrane due to the hydrogen peroxide or radicals.

The invention was achieved in light of the above circumstances. An object of the present invention is to provide a fuel cell system which prevents deterioration of a polymer electrolyte membrane in advance by directing the flow of liquid water from the cathode to anode.

### Solution to Problem

The fuel cell system of the present invention comprises a fuel cell which comprises a single cell comprising a membrane electrode assembly which comprises an anode electrode provided on one surface of a polymer electrolyte membrane and a cathode electrode provided on the other side of the polymer electrolyte membrane, wherein the fuel cell system comprises a means for controlling the fuel cell so that relative humidity RH_{C} inside the cathode electrode and relative humidity RH_{A} inside the anode electrode satisfy the following formula (1) at least when the fuel cell is in intermittent operation:

RH_{C}>RH_{A} Formula (1):

wherein RH_{C}≧100%.

In the present invention, preferably, the fuel cell system further comprises a means for determining whether or not liquid water is present inside the cathode electrode when the fuel cell is in at least any one of normal operation and intermittent operation, and the control means controls the fuel cell based on a result determined by the determination means.

In the present invention, preferably, liquid water is always stored inside the cathode electrode at least when the fuel cell is in intermittent operation.

In the present invention, preferably, the fuel cell system further comprises a means for humidifying the inside of the cathode electrode, and the humidifying means is operated when the fuel cell is in at least any one of intermittent operation and before intermittent operation.

In the present invention, preferably, the control means can be a means for controlling a single cell temperature and/or a temperature of a stack comprising two or more single cells.

### Advantageous Effects of Invention

According to the present invention, the flow of liquid water and/or water vapor is directed from the cathode electrode to the anode electrode by storing liquid water and/or water vapor inside the cathode electrode at least when a fuel cell is in intermittent operation and thus increasing the relative humidity inside the cathode electrode higher than that of the anode electrode; therefore, it is possible to decrease the concentration of hydrogen peroxide or radicals.

As a result, according to the present invention, it is possible to suppress the hydrogen peroxide and radicals from entering the polymer electrolyte membrane and thus to prevent decomposition of the polymer electrolyte membrane and a decrease in fuel cell properties.

### BRIEF DESCRIPTION OF DRAWINGS

FIG. 1 is a view showing an example of the single cell of the fuel cell used in the present invention, and it is also a schematic view of a cross section cut along the stacking direction.

FIG. 2 is a schematic sectional view of the membrane electrode assembly used in the present invention, the assembly being in intermittent operation.

FIG. 3 is a schematic diagram of mapping data used for monitoring.

FIG. 4 is a schematic diagram showing the relationship between the relative humidity difference between the cathode and anode electrodes and the flow speed of water which flows from the cathode electrode to the anode electrode.

FIG. 5 is a flow chart showing an example of the control of the fuel cell system of the present invention.

FIG. 6 is a bar graph showing molecular weight decrease rate ΔM of the membrane electrode assemblies of Example 1, Example 2, Comparative Example 1 and Comparative Example 2.

FIG. 7 is a bar graph showing voltage decrease rate ΔV of the membrane electrode assemblies of Example 1, Example 2, Comparative Example 1 and Comparative Example 2.

### DESCRIPTION OF EMBODIMENTS

A fuel cell system of the present invention comprises a fuel cell which comprises a single cell comprising a membrane electrode assembly which comprises an anode electrode provided on one surface of a polymer electrolyte membrane and a cathode electrode provided on the other side of the polymer electrolyte membrane, wherein the fuel cell system comprises a means for controlling the fuel cell so that relative humidity RH_{C} inside the cathode electrode and relative humidity RH_{A} inside the anode electrode satisfy the following formula (1) at least when the fuel cell is in intermittent operation:

RH_{C}>RH_{A} Formula (1):

wherein RH_{C}≧100%.

In a solid polymer electrolyte fuel cell, a polymer electrolyte membrane deteriorates over time. The deterioration is thought to occur because hydrogen peroxide and radicals generated in the fuel cell oxidizes the polymer electrolyte membrane to decompose the same. A decomposed product produced by the oxidization of the polymer electrolyte membrane has a possibility that it transfers to an electrode and poisons the catalyst in the electrode. When the decomposition of the polymer electrolyte membrane is significant, the polymer electrolyte membrane is broken. As just described, when the deterioration of the polymer electrolyte membrane is significant, there could be a serious negative impact on the properties of the entire fuel cell, such as charging and discharging properties.

A technique is known as a conventionally-known technique for preventing deterioration of a polymer electrolyte membrane, which is one that detects deterioration of a polymer electrolyte membrane by changing voltage over time and temporarily humidifies the polymer electrolyte membrane when the deterioration is detected. However, such a technique is a technique that controls humidity conditions after the occurrence of deterioration of a polymer electrolyte membrane, and it is not a technique that can prevent the deterioration itself.

Also, a technique is known as a conventionally-known technique for preventing deterioration of a polymer electrolyte membrane, which is one that totally increases the water content of a polymer electrolyte membrane and a catalyst layer in an electrode. However, even if water distribution in a fuel cell is controlled by the technique so as to totally increase the water content of a catalyst layer, it is difficult to prevent local deterioration of a polymer electrolyte membrane.

A technique is known as a conventionally-known technique for preventing deterioration of a polymer electrolyte membrane, which is one that controls gas upon starting up or stopping a fuel cell, which remains in the cell.

However, a main cause of the deterioration upon staring up or stopping the fuel cell is physical fracture, so that the technique cannot prevent chemical deterioration in a polymer electrolyte membrane due to oxidization of the same. Especially, it is considered to be impossible to sufficiently prevent a polymer electrolyte membrane from oxidation deterioration when a low load is applied thereon.

Deterioration of a polymer electrolyte membrane is caused because hydrogen gas supplied from an anode electrode passes through a polymer electrolyte membrane while oxygen gas supplied from the cathode electrode passes through the polymer electrolyte membrane at the same time. The inventor of the present invention focused attention on the fact that such gas permeation from the electrodes to the polymer electrolyte membrane is most significant when a fuel cell is in intermittent operation (in the case of an in-vehicle fuel cell, when the vehicle is idling). Based on this knowledge, the inventor of the present invention found out that it is possible to prevent decomposition of a polymer electrolyte membrane by storing liquid water in a cathode electrode mainly when a fuel cell is in intermittent operation and creating a flow of the liquid water from the cathode electrode to an anode electrode. The inventor of the present invention completed the present invention, therefore.

In conventional fuel cell systems, no attention has been paid to the state of liquid water when the fuel cell is in intermittent operation. Especially, no attempt has been made to control liquid water when the fuel cell is in intermittent operation in repeated cycles of intermittent operation and normal operation.

In the present invention, “liquid water” means a substance which is liquid under the operation and temperature condition of a fuel cell and which comprises water (H₂O) as a main component. In the present invention, therefore, liquid water encompasses not only water (that is, H₂O) which is in a liquid state but also aqueous solutions. In particular, liquid water encompasses water which is produced by the reaction represented by the formula (II), water in which oxygen and so on that are used for an electrode reaction of a fuel cell, are dissolved, and aqueous solutions which is produced by a side reaction of an electrode reaction of a fuel cell, such as an aqueous solution of hydrogen peroxide.

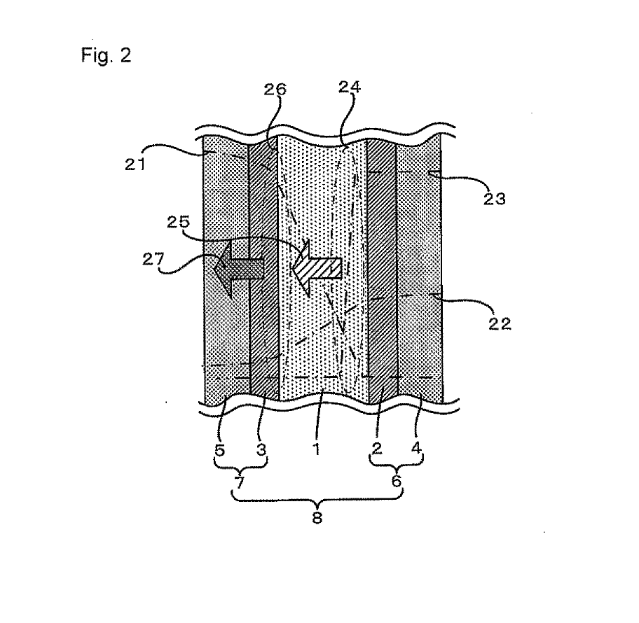

FIG. 2 is a schematic sectional view of the membrane electrode assembly used in the present invention, which is in intermittent operation. Double wavy lines mean that the rest of the figure is omitted. Partial pressure and electric potential which are schematically shown in FIG. 2 are estimates.

Membrane electrode assembly 8 comprises polymer electrolyte membrane 1, cathode electrode 6 and anode electrode 7. Polymer electrolyte membrane 1 is sandwiched between cathode electrode 6 and anode electrode 7. Cathode electrode 6 comprises a laminate of cathode catalyst layer 2 and gas diffusion layer 4, which are stacked in this order from closest to polymer electrolyte membrane 1. Anode electrode 7 comprises a laminate of anode catalyst layer 3 and gas diffusion layer 5, which are stacked in this order from closest to polymer electrolyte membrane 1. In FIG. 2, dashed line 21 means a partial pressure ratio of fuel gas supplied from the anode side; dashed line 22 means a partial pressure ratio of oxidant gas supplied from the cathode side; and dashed line 23 means an electric potential inside membrane electrode assembly 8. An electrode reaction proceeds inside frame 24 shown by dashed line, that is, in an area where the partial pressure ratio of the fuel gas is substantially the same as that of the oxidant gas, thereby producing liquid water. The flow of the liquid water is represented by arrow 25. The area inside frame 26 shown by dashed line is an area where hydrogen peroxide and radicals produced at the anode electrode are likely to be condensed. The hydrogen peroxide and radicals can be discharged to the outside of the fuel cell by creating the flow of the liquid water as represented by arrow 25 inside the membrane electrode assembly to dissolve the hydrogen peroxide and radicals remaining inside or around frame 26 in the liquid water and then by moving the liquid water along the flow as represented by arrow 27.

Storing liquid water in the cathode electrode when the fuel cell is in intermittent operation is absolutely different from flooding, which has been found to be a problem. Flooding is a phenomenon in which, due to the water movement from the anode electrode side and the water production inside the cathode electrode due to the electrode reaction, the content of water which is present mainly inside the cathode electrode becomes excess and the water is condensed inside the cathode electrode to be water droplets, thereby closing holes.

When the fuel cell is in normal operation, it is needed to diffuse a more amount of oxygen inside the cathode electrode; therefore, storing a large amount of liquid water inside the cathode electrode is a disadvantage. However, in intermittent operation, it is not necessary to take into account a decrease in voltage of the fuel cell; therefore, the disadvantage is not a problem.

The fuel cell system of the present invention comprises at least a fuel cell and a means for controlling the fuel cell. In addition to the fuel cell and the control means, the present invention can comprise a determination means and humidifying means as described below, for example.

Hereinafter, the fuel cell and the means for controlling the fuel cell will be explained in order.

### 1. Fuel Cell

The fuel cell used in the present invention is not particularly limited as long as it is a solid polymer type fuel cell that uses a polymer electrolyte membrane. Applicable fuel gas is not limited to hydrogen gas, and there may be used hydrocarbon gas such as methane and ethane, and alcohol such as methanol and ethanol, for example. Applicable oxidant gas is not limited to oxygen gas, and there may be used air, for example.

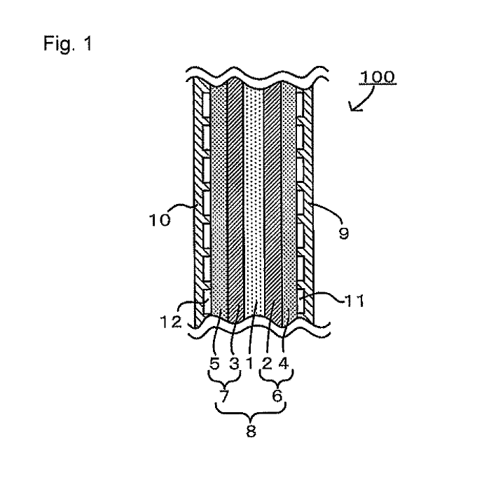

FIG. 1 is a view showing an example of the single cell of the fuel cell used in the present invention, and it is also a schematic view of a cross section cut along the stacking direction. Single cell 100 comprises hydrogen ion-conducting polymer electrolyte membrane (hereinafter simply may be referred to as electrolyte membrane) 1; membrane electrode assembly 8 comprising a pair of cathode electrode 6 and anode electrode 7 sandwiching the electrolyte membrane 1; and a pair of separators 9 and 10 sandwiching membrane electrode assembly 8 from the outside of the electrodes. Gas channels 11 and 12 are each present at the boundary between each separator and each electrode. In general, one produced by stacking a catalyst layer and gas diffusion layer in this order from the electrolyte membrane side, is used as each electrode. In particular, cathode electrode 6 comprises a laminate of cathode catalyst layer 2 and gas diffusion layer 4, while anode electrode 7 comprises a laminate of anode catalyst layer 3 and gas diffusion layer 5.

The polymer electrolyte membrane is a polymer electrolyte membrane which is generally used for fuel cells. The examples include fluorine-containing polymer electrolyte membranes comprising a fluorine-based polymer electrolyte such as a perfluorocarbon sulfonic acid polymer as typified by Nafion (trade name); and hydrocarbon-containing polymer electrolyte membranes comprising a hydrocarbon-based polymer electrolyte, which are obtained by introducing a protonic acid group (proton conductive group) such as a sulfonic acid group, carboxylic acid group, phosphate group or boronic acid group into a hydrocarbon-based polymer such as an engineering plastic (e.g., polyether ether ketone, polyether ketone, polyethersulfone, polyphenylene sulfide, polyphenylene ether, polyparaphenylene) or commodity plastic (e.g., polyethylene, polypropylene, polystyrene).

It is an advantage of the present invention that it is possible to prevent deterioration of a polymer electrolyte membrane such as a hydrocarbon-containing polymer electrolyte membrane as mentioned above, which is obtained at a relatively low cost. Even in the case of using a fluorine-containing polymer electrolyte membrane, it is possible to reduce a fluorine content in the liquid water discharged to the outside of the fuel cell. As a result, it is less probable that other fuel cell members such as metals (e.g., stainless steel, iron) are corroded, so that there is an advantage that corrosion prevention processes such as gold plating can be simplified and can be performed at lower costs than ever.

The electrodes comprise a catalyst layer and a gas diffusion layer each.

Each of the anode catalyst layer and the cathode catalyst layer can be produced by using a catalyst ink comprising a catalyst, a conductive material and a polymer electrolyte.

As the polymer electrolyte, materials which are the same as those of the polymer electrolyte membrane mentioned above, can be used.

As the catalyst, a catalyst component supported by conductive particles is generally used. The catalyst component is not particularly limited as long as it has catalytic activity on oxidation of the fuel supplied to the anode or reduction of the oxidant supplied to the cathode. As the catalyst component, those that are generally used for solid polymer type fuel cells can be used. For example, there may be used platinum or an alloy of platinum and a metal such as ruthenium, iron, nickel, manganese, cobalt or copper.

As the conductive particles, which is a catalyst support, there may be used a conductive carbonaceous material such as carbon particles (e.g., carbon black) or carbon fiber, or a metallic material such as metallic particles or metallic fiber. The conductive material also acts as a conductive material which imparts electrical conductivity to the catalyst layer.

The method for forming the catalyst layer is not particularly limited. For example, the catalyst layer can be formed on a gas diffusion layer sheet by applying the catalyst ink on a surface of the sheet and drying the applied ink. Or, the catalyst layer can be formed on the polymer electrolyte membrane by applying the catalyst ink on a surface of the polymer electrolyte membrane and drying the applied ink. Or, the catalyst layer can be formed on the polymer electrolyte membrane or gas diffusion layer sheet by the following method: the catalyst ink is applied on a surface of a substrate for transfer and drying the applied ink, thereby forming a transfer sheet; the transfer sheet is attached to the polymer electrolyte membrane or gas diffusion sheet by hot pressing or the like; then, a substrate film of the transfer sheet is removed therefrom.

The catalyst ink can be obtained by dissolving or dispersing a catalyst, an electrolyte for electrode or the like in a solvent. The solvent of the catalyst ink can be appropriately selected. Those that can be used as the solvent include organic solvents, mixtures of organic solvents and mixtures of water and organic solvents, the organic solvents including alcohols such as methanol, ethanol and propanol, N-methyl-2-pyrrolidone (NMP) and dimethylsulfoxide (DMSO). In addition to the catalyst and electrolyte, the catalyst can contain other component (s) as needed, such as a binding agent and water repellent resin.

The method for applying the catalyst ink, the method for drying the catalyst ink, etc., can be appropriately selected. As the method for applying the catalyst ink, there may be mentioned a spraying method, a screen printing method, a doctor blade method, a gravure printing method, a die coating method, etc. As the method for drying the catalyst ink, there may be mentioned drying under reduced pressure, heat drying, heat drying under reduced pressure, etc. The conditions for drying under reduced pressure and heat drying are not particularly limited and can be appropriately determined. The thickness of the catalyst layer is not particularly limited and can be about 1 to 50 μm.

As the gas diffusion layer sheet comprising the gas diffusion layer, there may be mentioned one which has a gas diffusion property that enables efficient fuel supply to the catalyst layer, electrical conductivity, and a strength that is required for a material which constitutes the gas diffusion layer. The examples include carbonaceous porous materials such as carbon paper, carbon cloth, carbon felt, and conductive porous materials such as metallic meshes and metallic porous materials which comprise metals such as titanium, aluminum, copper, nickel, nickel-chromium alloys, copper alloys, silver, aluminum alloys, zinc alloys, lead alloys, titanium, niobium, tantalum, iron, stainless steel, gold and platinum. The thickness of the conductive porous materials is preferably about 50 to 500 μm.

The gas diffusion layer sheet can be a single layer comprising any of the above conductive porous materials. Or, a water repellent layer can be provided on the side which faces the catalyst layer. The water repellent layer is generally one which comprises a water repellent resin such as polytetrafluoroethylene (PTFE) or a conductive powder-particle material such as carbon particles or carbon fiber, and which has a porous structure. The water repellent layer is not essential; however, it has an advantage that it can increase the drainage property of the gas diffusion layer, while keeping the liquid water content in the catalyst layer and polymer electrolyte membrane at an appropriate level; moreover, it can improve the electrical contact between the catalyst layer and the gas diffusion layer.

The polymer electrolyte membrane and gas diffusion layer sheet, any of which has the catalyst layer formed thereon by the above method, are appropriately stacked and attached to each other by heat pressing, etc., thereby obtaining a membrane electrode assembly.

The thus-produced membrane electrode assembly is preferably sandwiched by separators to form a single cell. The separators preferably have a reaction gas channel each. As the separators, there may be used those that have electrical conductivity and a gas sealing property and that can function as a current collector and gas sealing member. The examples include carbon separators which contain a high concentration of carbon fiber and comprise a composite material with a resin, and metallic separators comprising a metallic material. As the metallic separators, there may be mentioned those comprising a metallic material with excellent corrosion resistance, and those having a surface that is covered with carbon or a metallic material with excellent corrosion resistance so as to provide a coating for increasing corrosion resistance. The reaction gas channels can be formed by appropriately performing compression molding, cutting, etc., on the separators.

### 2. Fuel Cell Control Means

The control means used in the present invention is a means for controlling the fuel cell so that relative humidity RH_{C} inside the cathode electrode is 100% or more and relative humidity RH_{C} exceeds relative humidity RH_{A} inside the anode electrode at least when the fuel cell is in intermittent operation. The relationship between RH_{C} and RH_{A} is represented by the following formula (1):

RH_{C}>RH_{A} Formula (1):

wherein RH_{C}≧100%.

Each of RH_{C} and RH_{A} is calculated by the following formula: RH={water vapor pressure (measured value)/saturated water vapor pressure}×100. When RH>100%, each of RH_{C} and RH_{A} is one obtained by subjecting water in a liquid state to RH conversion.

In the present invention, the intermittent operation of the fuel cell system means an operating state in which operation of the fuel cell is suspended and, mainly in the case where the fuel cell is installed on a vehicle, etc., it means an operating state which is selected when the vehicle is idling or under low load (e.g., decreasing the speed). In intermittent operation, generally, the open circuit voltage (OCV) or a high voltage of 0.8 V or more is applied to the fuel cell.

The fuel cell system of the present invention is preferably a system which can perform normal operation besides intermittent operation. The normal operation of the fuel cell system means a state in which the fuel cell is operated under normal conditions and, mainly in the case where the fuel cell is installed on a vehicle, etc., it means an operation state which is selected when the vehicle is driving normally or under high load (e.g., increasing the speed).

In the present invention, the fuel cell system can further comprise a means for selecting any one of normal operation mode and intermittent operation mode and executing the selected mode.

The first feature of the present invention is that relative humidity RH_{C} inside the cathode electrode is 100% or more, that is, liquid water is present inside the cathode electrode when the fuel cell is in intermittent operation, that is, at a high voltage of 0.8 V or more. As explained above, when the fuel cell system of the present invention is installed on a vehicle, what is meant by “the fuel cell is at a high voltage” includes the case where the vehicle is idling.

As shown by the formula (1), the second feature of the present invention is that relative humidity RH_{C} inside the cathode electrode exceeds relative humidity RH_{A} inside the anode electrode when the fuel cell is in intermittent operation.

When the fuel cell is in intermittent operation, by storing liquid water inside the cathode electrode and making a difference in water concentration between the cathode and anode electrodes, more specifically, making a difference in relative humidity between the electrodes, a flow of the liquid water from the cathode electrode side to the anode electrode side is created. The flow of the liquid water makes it possible to discharge hydrogen peroxide and radicals produced inside the fuel cell to the outside of the fuel cell; therefore, deterioration of a polymer electrolyte membrane is prevented.

In the present invention, it is preferable that no liquid water is present inside the anode electrode at least before the control means is executed, from the point of view that the difference in water concentration between the cathode and anode electrodes can be larger and a larger amount of liquid water can be directed to the anode electrode.

The presence of liquid water inside the fuel cell can be confirmed by monitoring the fuel cell using the following values solely or in combination: a calculated value obtained by calculation in advance, an actual measured value obtained by measurement, a value obtained from a mapping prepared in advance based on experimental rules, etc.

Monitoring positions are preferably at the inlet and outlet of the fuel gas and oxidant gas channels and around the middle of each channel so that the distribution of liquid water inside the fuel cell can be accurately understood. The number of monitoring positions is preferably five or more positions including the preferred monitoring positions.

In the case where only the number of monitoring positions is limited to one position due to conditions such as the whole structure or cost of the fuel cell system, it is preferable to monitor the inlet of the oxidant gas channel at which the liquid water amount is considered to be the smallest amount. It is preferable to monitor all fuel cells in a fuel cell stack. Especially in the case where there is a limitation on the monitoring position from the viewpoint of car design, it is preferable to monitor a fuel cell which is positioned in the center of the fuel cell stack. This is because, in a fuel cell stack in which fuel cells are connected in series, the heat radiation efficiency of a fuel cell which is positioned in the center of the fuel cell stack is low and liquid water evaporation is more significant.

When monitoring the fuel cell, the operation state of the fuel cell is recorded at fixed time intervals. The liquid water amount is calculated from the operation state of the fuel cell for a past fixed period starting from a predetermined point, for example, a point at which it is requested to determine whether or not liquid water is present inside the cathode electrode. The operation state of the fuel cell is preferably recorded at intervals of several seconds to several minutes, more preferably at one-second intervals. To calculate the liquid water amount, it is preferable to refer to an operation state of the fuel cell for past several seconds to several minutes, and it is more preferable to refer to a record for past several tens of seconds.

The calculated value used for monitoring can be estimated from the following: a saturated water vapor pressure at a predetermined cell temperature, a humidifying condition such as a relative humidity at the gas channel inlet side, a flow rate of gas supplied to the fuel cell, an amount of liquid water produced by electrode reaction, a total pressure (back pressure) of gas supplied to the fuel cell, etc. The saturated water vapor pressure at a predetermined cell temperature can be a saturated water vapor pressure obtained by Antoine equation or one obtained based on experimental rules.

The actual measured value used for monitoring is a value obtained with a measuring device such as a hygrometer, dew-point meter or moisture meter. The measuring device is preferably installed inside the fuel cell or stack.

The empirical value used for monitoring is a value which is obtained by obtaining liquid water behavior in advance regarding parameters and making a database thereof, the parameters including temperature, gas flow rate, humidifying condition, discharging amount and time, etc. When the fuel cell system of the present invention is installed on a vehicle, the state of the vehicle can be checked with the database and used to determine whether or not liquid water is present inside the cathode electrode.

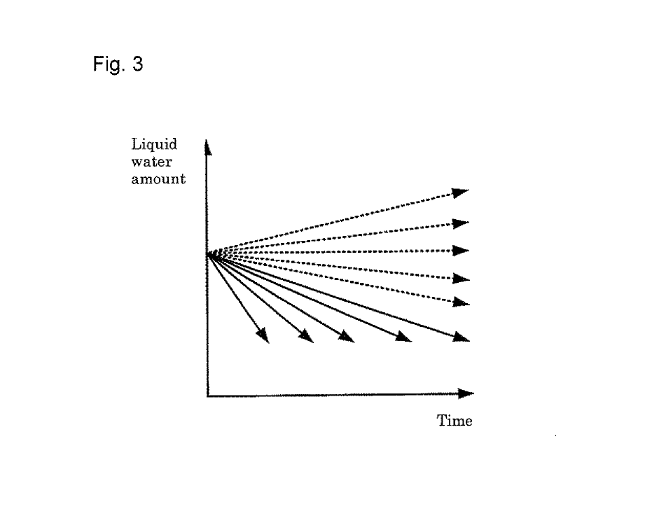

FIG. 3 is a schematic diagram of mapping data used for monitoring. The mapping data is a graph plotting liquid water amount on the vertical axis and time on the horizontal axis.

In the mapping data, dashed arrows mean liquid water amount data varied over time by parameters such as humidifying and discharging conditions, while solid arrows mean liquid water amount data varied over time by parameters such as a cell temperature and gas flow speed. The liquid water amount is relative to and thus can be estimated from the operation condition of the fuel cell by obtaining such mapping data in advance and making a database thereof.

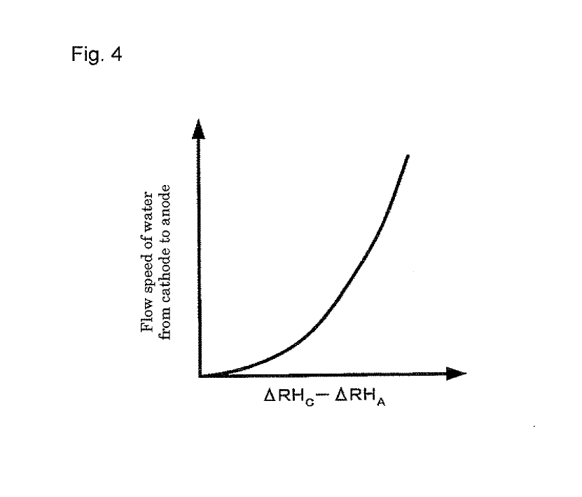

FIG. 4 is a schematic diagram showing the relationship between the relative humidity difference between the cathode and anode electrodes and the flow speed of water which flows from the cathode electrode to the anode electrode. As is clear from FIG. 4, the larger the relative humidity difference between the cathode and anode electrodes, the faster the flow speed of water which flows from the cathode electrode to the anode electrode. An appropriate humidifying condition can be selected by performing monitoring with reference to such data.

A means for memorizing a monitoring result can be further provided. The number of monitoring results that should be memorized can be one result or two or more results. Or, it is possible to store a map of one monitoring result or two or more monitoring results in the memorizing means and to sequentially call a map which is appropriate for the below-described determination means. The memorizing means can also memorize the above-described calculated value, actual measured value, empirical value, etc. The memorizing means can be electrically connected with the above-described measuring device.

The memorizing means can be a means which reads a physical value fed back from the below-described determination means as a new monitoring result, the value showing the operation state of the fuel cell at a predetermined stage. By sequentially updating monitoring results in this manner, time-dependent data on the operation state of the fuel cell, especially on the deterioration state of the polymer electrolyte membrane, can be obtained.

Concrete examples of the means for storing monitoring results include semiconductor memory devices for memorizing a predetermined monitoring result, such as a memory, and magnetic storage devices such as a hard disk.

In the present invention, it is more preferable that the fuel cell system further comprises a means for determining whether or not liquid water is present inside the cathode electrode, based on the results obtained by monitoring. In this case, only the cathode electrode when the fuel cell is in intermittent operation, can be subjected to the determination; however, the cathode electrode when the fuel cell is in normal operation can be also subjected to the determination.

The determination means can be a device which is electrically connected with the memorizing means and operates simultaneously with the same. Also, the determination means can be apart of the data stored in the memorizing means and a command itself called from the memorizing means.

The determination means is preferably a means for comparing a predetermined threshold value for the standard of liquid water amount inside the cathode electrode with a monitoring result and then making a determination. The threshold value can be a threshold value itself of the liquid water amount inside the cathode electrode, or it can be a predetermined physical value on mapping data, from which the liquid water amount inside the cathode electrode can be estimated.

In the present invention, the control means controls a single cell temperature, a temperature of a stack comprising two or more single cells (hereinafter, the two types of temperatures may be referred to as “single cell temperature, etc.”), a humidifying condition, a flow rate of gas supplied to the fuel cell, a back pressure of the gas, a discharging amount, etc., preferably based on a result determined by the determination means. Chemical deterioration of a polymer electrolyte membrane can be further suppressed by controlling them. It is preferable that liquid water is stored inside the cathode electrode by controlling them at least when the fuel cell is in intermittent operation.

(1) When controlling the single cell temperature, etc., it is preferable to decrease the single cell temperature, etc. This is because the saturated water vapor pressure inside the fuel cell is decreased by decreasing the single cell temperature, etc., so that liquid water can be stored inside the cathode electrode. When the fuel cell is in normal operation, the cell temperature increases as the discharging amount increases. However, if the fuel cell is changed to intermittent operation while keeping the single cell temperature, etc., high, there is a possibility that the liquid water inside the cathode electrode disappears rapidly. In the present invention, even if the fuel cell is changed to intermittent operation while the single cell temperature, etc., are kept high, it is possible to prevent the liquid water inside the cathode from evaporation by decreasing the single cell temperature, etc., when the fuel cell is in intermittent operation.

(2) When controlling the humidifying condition, it is preferable to increase the humidity. This is because the relative humidity inside the electrodes is increased higher than the saturated water vapor pressure by increasing the humidity, so that liquid water can be stored inside the cathode electrode.

(3) When controlling the gas flow rate, it is preferable to decrease the gas flow rate. This is because the saturated water vapor pressure per unit time is increased by decreasing the gas flow rate, so that it becomes easy to store liquid water inside the cathode electrode.

(4) When controlling the back pressure, it is preferable to increase the back pressure. This is because the water vapor pressure is increased by increasing the back pressure, without changing the saturated water vapor pressure, so that it becomes easy to concentrate liquid water inside the cathode electrode.

(5) When controlling the discharging amount, it is preferable to increase the discharging amount. The amount of liquid water produced by the above formula (II) can be increased by increasing the discharging amount, so that liquid water can be stored inside the cathode electrode.

Preferably, the fuel cell system of the present invention further comprises a means for humidifying the inside of the cathode electrode. By being executed when the fuel cell is in or before intermittent operation, the humidifying means can control the humidity so as to satisfy the condition represented by the formula (1) when the fuel cell is in intermittent operation. What is meant by “before intermittent operation” is a stage where the fuel cell is in normal operation and before it is changed to intermittent operation.

Concrete examples of the humidifying means include humidifiers which have been used for fuel cells.

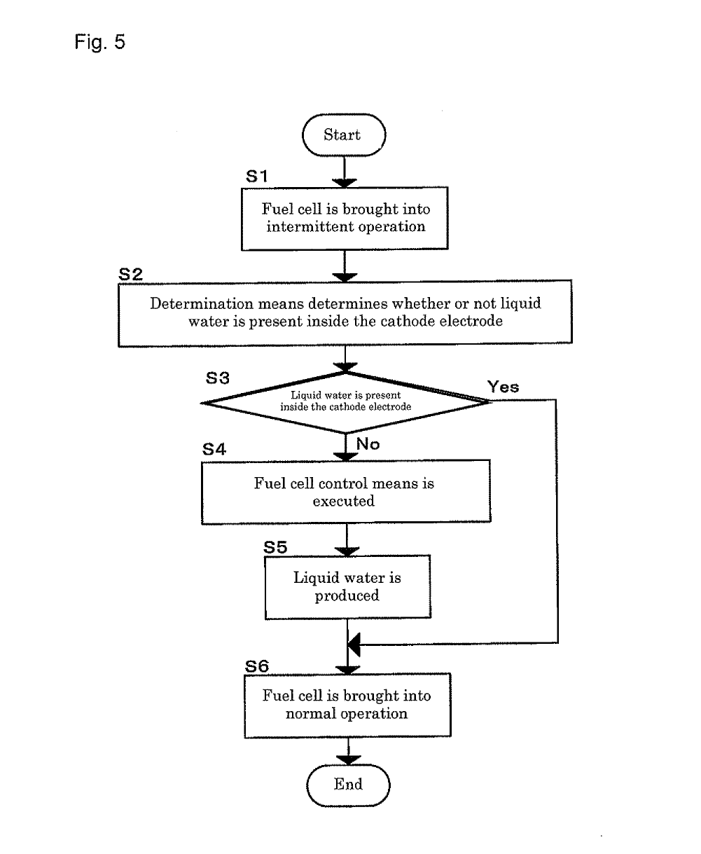

FIG. 5 is a flow chart showing an example of the control of the fuel cell system of the present invention. Hereinafter, a control example of the present invention will be explained, according to the order shown in the flow chart of FIG. 5.

First, the fuel cell system is brought into intermittent operation (S1). In intermittent operation, the fuel cell is in a high voltage state where the OCV or a high voltage of 0.8 V or more is applied thereto. Next, it is determined by the determination means whether or not a predetermined amount of liquid water is present inside the cathode electrode (S2). At this time, conditions such as threshold are predetermined in advance, and if the conditions are not satisfied, it is determined that a predetermined amount of liquid water is not present inside the cathode electrode (S3). If the conditions are satisfied, it is determined that a predetermined amount of liquid water is present inside the cathode electrode, and the fuel cell is brought into normal operation (S6).

When it is determined that a predetermined amount of liquid water is not present inside the cathode electrode, the means for controlling the fuel cell is executed (S4). The control means is a means which controls at least one of the following mentioned above: (1) single cell temperature, etc., (2) humidifying condition, (3) gas flow rate, (4) back pressure and (5) discharging amount. The control means can control only one of them or two or more of them. Or, two or more of them can be performed at the same time or one by one in order. Liquid water is produced by controlling one or two or more of them (S5).

After the production of liquid water, the fuel cell is brought into normal operation and then control of the fuel cell system is terminated (S6). At this time, it is allowed that after the fuel cell is in normal operation for a fixed time (e.g., a few seconds), the fuel cell is brought into intermittent operation again to restart the system control (S1). As just described, by operating the fuel cell in normal operation only for a short time and then operating the same in intermittent operation again, it is possible to monitor the liquid water amount at the time when the fuel cell is in normal operation.

The fuel cell system of the present invention is not limited to in-vehicle applications and has a wide range of possible applications. It can be applied to all power generation systems provided with a solid polymer type fuel cell, such as a stationary fuel cell system and a compact fuel cell system.

### EXAMPLES

Hereinafter, the present invention will be described further in detail by way of examples and comparative examples. However, the scope of the present invention is not limited to the examples.

### 1. Production of Membrane Electrode Assembly

An anode electrode catalyst paste was applied by spraying to one surface of a hydrocarbon-containing polymer electrolyte membrane, the paste comprising a proton-conductive electrolyte and an electrode catalyst comprising platinum. A cathode electrode catalyst paste was applied by spraying to the other surface of the membrane, the paste comprising a proton-conductive electrolyte and an electrode catalyst comprising platinum. After the application by spraying, the polymer electrolyte membrane was sandwiched by a pair of gas diffusion sheets (carbon paper) and heat-pressed, to produce a membrane electrode assembly.

### 2. Endurance Test

The membrane electrode assemblies were subjected to an endurance test for a fixed time duration, in which load change cycles of high potential condition and discharging condition were repeated in the condition of Example 1, Example 2, Comparative Example 1 or Comparative Example 2 as shown in Table 1 below. Hereinafter, the membrane electrode assemblies subjected to the endurance test in the condition of Example 1, Example 2, Comparative Example 1 and Comparative Example 2 may be referred to as “membrane electrode assembly of Example 1,” “membrane electrode assembly of Example 2,” “membrane electrode assembly of Comparative Example 1” and “membrane electrode assembly of Comparative Example 2,” respectively.

The cathode and anode relative humidities shown in Table 1 are relative humidities in high potential conditions. In the membrane electrode assemblies of Examples 1 and 2, liquid water was present in the cathode electrode of each assembly in the high potential condition shown in Table 1. The cathode relative humidity of the membrane electrode assembly of Example 1 was obtained by calculation of the liquid water to RH conversion and is 162%. The cathode relative humidity of the membrane electrode assembly of Example 2 was obtained by calculation of the liquid water to RH conversion and is 241%.

TABLE 1

| | | | Compar- | Compar- |
|---|---|---|---|---|
| | Exam- | Exam- | ative | ative |
| | ple 1 | ple 2 | Example 1 | Example 2 |
| Cell temperature (° C.) | 70 | 70 | 80 | 70 |
| Anode dew point (° C.) | 45 | 45 | 45 | 45 |
| Cathode dew point (° C.) | 55 | 55 | 55 | 55 |
| High potential condition (V) | 0.85 | 0.85 | OCV | 0.85 |
| Discharging condition | 1.2 | 0.1 | 0.1 | 0.1 |
| (A/cm²) | | | | |
| Cathode partial pressure ratio | 1.5 | 1.7 | 2.0 | 2.0 |
| Time duration of test (h) | 500 | 430 | 400 | 400 |
| Cathode relative humidity (%) | 100 | 100 | 3.3 | 50 |
| Anode relative humidity (%) | 31 | 31 | 20 | 31 |

### 3. Measurement of Molecular Weight

After the endurance test, a catalyst layer was removed from each membrane electrode assembly using a waste cloth impregnated with ethanol. Next, to remove metal ions from the polymer electrolyte membrane of each membrane electrode assembly, the polymer electrolyte membrane was immersed in 0.1 mol/L hydrochloric acid for one night. Then, the polymer electrolyte membrane was taken out of the hydrochloric acid, washed with ultrapure water and then dried. Molecular weight measurement was performed by GPO method on the polymer which comprises the polymer electrolyte membrane. Molecular weight decrease rate ΔM (%/h) was calculated by the following formula (A):

ΔM={(M₀−M₁)/(M₀·T)}×100 Formula (A):

wherein M₀ is the molecular weight of the polymer comprising the polymer electrolyte membrane before the endurance test; M₁ is the molecular weight of the polymer comprising the polymer electrolyte membrane after the endurance test; and T is the time duration of the endurance test (h).

### 4. Measurement of Decrease in Voltage

Before and after the endurance test, each of the membrane electrode assemblies was measured for the voltage at a current density of 1.6 A/cm² in the condition of a cell temperature of 70° C., an anode dew point of 45° C., a cathode dew point of 55° C. Voltage decrease rate ΔV (mV/h) was measured by the following formula (B):

ΔV=(V₀−V₁)/T Formula (B):

wherein V₀ is the voltage before the endurance test; V₁ is the voltage after the endurance test; T is the time duration of the endurance test (h).

### 5. Evaluation

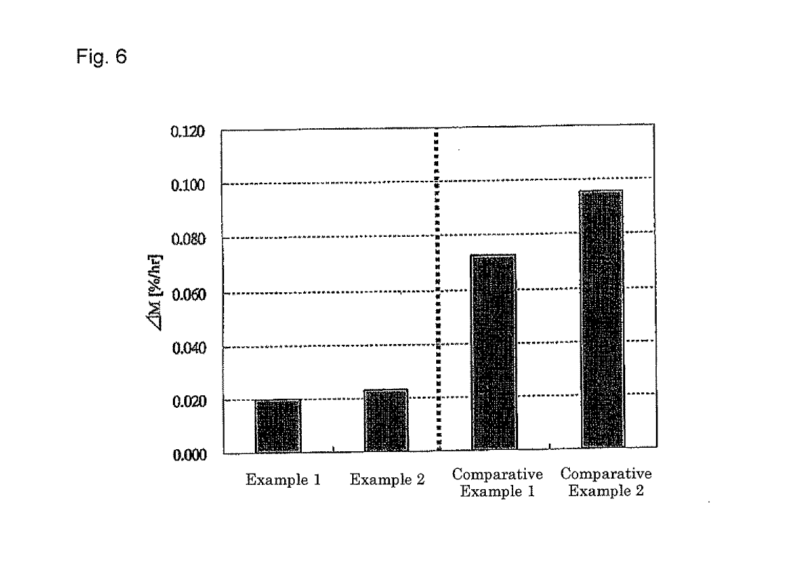

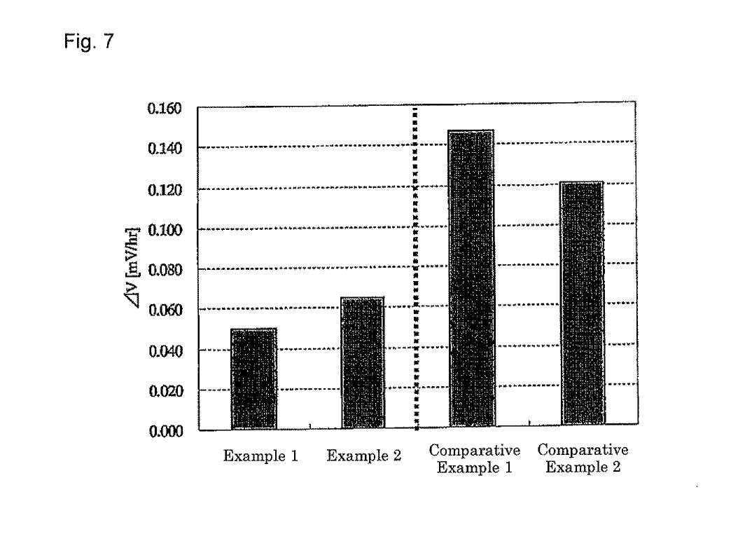

FIG. 6 is a bar graph showing molecular weight decrease rate ΔM of the membrane electrode assemblies of Examples 1 and 2 and Comparative Examples 1 and 2. FIG. 7 is a bar graph showing voltage decrease rate ΔV of the membrane electrode assemblies of Examples 1 and 2 and Comparative Examples 1 and 2.

As is clear from FIG. 6, ΔM of Comparative Example 1 is 0.073 (%/h) and ΔM of Comparative Example 2 is 0.096 (%/h). On the other hand, ΔM of Example 1 is 0.020 (%/h) and ΔM of Example 2 is 0.023 (%/h). These results show that ΔM of Examples 1 and 2 are less than one-third of ΔM of Comparative Examples 1 and 2; therefore, it is clear that in the membrane electrode assemblies of Examples 1 and 2, deterioration of the polymer electrolyte membrane were suppressed more significantly than the membrane electrode assemblies of Comparative Examples 1 and 2.

As is clear from FIG. 7, ΔV of Comparative Example 1 is 0.147 (mV/h) and ΔV of Comparative Example 2 is 0.121 (mV/h). On the other hand, ΔV of Example 1 is 0.050 (mV/h) and ΔV of Example 2 is 0.065 (mV/h). These results show that ΔV of Examples 1 and 2 are about one-half or less of ΔV of Comparative Examples 1 and 2; therefore, it is clear that in the membrane electrode assemblies of Examples 1 and 2, voltage decrease was suppressed more significantly than the membrane electrode assemblies of Comparative Examples 1 and 2.

### REFERENCE SIGNS LIST

1. Polymer electrolyte membrane
2. Cathode catalyst layer
3. Anode catalyst layer
4,5. Gas diffusion layer
6. Cathode electrode
7. Anode electrode
8. Membrane electrode assembly
9, 10. Separator
11, 12. Gas channel
21. Dashed line showing the partial pressure ratio of fuel gas supplied from the anode side
22. Dashed line showing the partial pressure ratio of oxidant gas supplied from the cathode side
23. Dashed line showing the electric potential inside the membrane electrode assembly.
24. Frame showing an area where the partial pressure ratio of the fuel gas is substantially the same as that of the oxidant gas
25. Arrow showing the flow of liquid water inside the membrane electrode assembly
26. Frame showing an area where hydrogen peroxide and radicals produced at the anode electrode are likely to be condensed
27. Arrow showing the flow of liquid water comprising hydrogen peroxide and radicals
100. Single cell

1. A fuel cell system comprising a fuel cell which comprises a single cell comprising a membrane electrode assembly which comprises an anode electrode provided on one surface of a polymer electrolyte membrane and a cathode electrode provided on the other side of the polymer electrolyte membrane,
wherein the fuel cell system comprises a means for controlling the fuel cell so that relative humidity RH_{C} inside the cathode electrode and relative humidity RH_{A} inside the anode electrode satisfy the following formula (1) at least when the fuel cell is in intermittent operation:
RH_{C}>RH_{A} Formula (1):
wherein RH_{C}≧100%.

2. The fuel cell system according to claim 1,
wherein the fuel cell system further comprises a means for determining whether or not liquid water is present inside the cathode electrode when the fuel cell is in at least any one of normal operation and intermittent operation, and
wherein the control means controls the fuel cell based on a result determined by the determination means.

3. The fuel cell system according to claim 1, wherein liquid water is always stored inside the cathode electrode at least when the fuel cell is in intermittent operation.

4. The fuel cell system according to claim 1,
wherein the fuel cell system further comprises a means for humidifying the inside of the cathode electrode, and
wherein the humidifying means is operated when the fuel cell is in at least any one of intermittent operation and before intermittent operation.

5. The fuel cell system according to claim 1, wherein the control means is a means for controlling a single cell temperature
and/or a temperature of a stack comprising two or more single cells.
